(19) United States
(12) Patent Application Publication
(10) Pub. No.: US 2016/0355292 A1
(43) Pub. Date: Dec. 8, 2016

(54) MODULE WRAP FEED SYSTEM

(71) Applicant: DEERE & COMPANY, MOLINE, IL (US)

(72) Inventors: Jeffrey S. Wigdahl, AMES, IA (US); HENRY D. ANSTEY, OTTUMWA, IA (US); JASON C. EUBANKS, HEDRICK, IA (US); JERRY B. HALL, JOHNSTON, IA (US)

(21) Appl. No.: 14/730,012

(22) Filed: Jun. 3, 2015

(51) Int. Cl. B65B 57/04; B65B 11/04; A01F 15/07

(52) U.S. Cl. CPC B65B 57/04; A01F 15/071; B65B 11/04; A01F 2015/076

(57) ABSTRACT

A wrap feed system is provided for an agricultural harvesting machine having a module-forming arrangement. A wrap feeding arrangement delivers wrapping material from a wrapping material supply to the module-forming arrangement, which is disposed in a module-forming chamber. A guide arrangement guides the wrapping material from the wrapping material supply to the wrap feeding arrangement. A sensor arrangement has at least one detection field directed toward at least one of the wrapping material supply, the wrap feeding arrangement, the guide arrangement and an inlet of the module-forming chamber to detect at least one of a module and the wrapping material.

### CROSS-REFERENCE TO RELATED APPLICATION(S)

Not Applicable.

### STATEMENT REGARDING FEDERALLY SPONSORED RESEARCH

Not Applicable.

### FIELD OF THE DISCLOSURE

This disclosure relates to crop harvesting machines with baling and wrapping arrangements, and more specifically, to the detection and prevention of incorrectly fed or oriented wrapping material arising during a wrapping cycle.

### BACKGROUND OF THE DISCLOSURE

Harvested cotton, hay or other crops, or crop by-products such as straw, may be collected and processed through a module-forming apparatus, such as a baler, to produce modules (e.g., round or square bales) of the harvested crop or crop by-products. The module-forming apparatus may be equipped with a wrapping system to bind the module together with wrap material (e.g., twine, net, sheet wrap, etc.). For example, U.S. Pat. No. 6,263,650 discloses a cotton harvesting machine having a round module-forming and wrapping apparatus. The wrapped module may then be transferred from the module-forming apparatus such that the formation of a new module may begin. The wrapped module may be temporarily retained on the harvesting machine before being ejected at a given location, such as at the end of a row in a field of crops, for later transport.

The module-forming and wrapping apparatus may utilize individual, properly sized wraps. The apparatus may also have the capability of separating a predetermined length of wrapping material from a supply roll for applying a desired number of layers of wrap to the module. For example, U.S. Pat. No. 6,787,209 discloses separating pre-partitioned lengths of wrapping material from the supply roll. Other systems may measure the length of continuous wrapping material (e.g., via timers, position sensors, rotation counters, and the like), and thereby determine where to cut the wrapping material from the supply roll.

One challenge arising in module wrapping relates to mis-feeding of the wrapping material. For example, the wrapping material may be improperly guided into the module-forming chamber, or the wrapping material may become incorrectly oriented, folded, or otherwise positioned out of alignment. As a consequence, a module may improperly wrapped or not at all. These mis-wrap events may also result in equipment down time, wasted wrapping material, and exposure of the modules to dirt, moisture, and the like when ejected from the harvesting machine.

### SUMMARY OF THE DISCLOSURE

This disclosure provides a module-forming and wrapping system for agricultural harvesting machines which monitors the state of the module or wrapping material during a wrapping operation.

In one aspect, the disclosure provides a wrap feed system for a module-forming arrangement in an agricultural harvesting machine. The wrap feed system includes a wrap feeding arrangement for delivering wrapping material from a wrapping material supply to the module-forming arrangement, which is disposed in a module-forming chamber having an inlet. A may guide the wrapping material from the wrapping material supply to the wrap feeding arrangement. A sensor arrangement has at least one detection field directed toward at least one of the wrapping material supply, the wrap feeding arrangement, the guide arrangement and the module-forming chamber inlet to detect at least one of a module and the wrapping material.

Another aspect the disclosure provides a wrap feed system for a module-forming arrangement in an agricultural harvesting machine having a wrap feeding arrangement, at least one wrap feed roll positioned intermediate the wrapping material supply and the wrap feeding arrangement, and a multi-sensor arrangement with first and second sensors having respective first and second detection fields. The first detection field may be directed toward at least one of the wrapping material supply, the wrap feeding arrangement and the at least one wrap feed roll to detect the wrapping material. The second detection field may be directed across the module-forming chamber inlet to detect at least a portion of the module extending into the module-forming chamber inlet. A control system has at least one controller operatively coupled to the first and second sensors and configured to receive sensor input and output a feedback signal indicative of a mis-wrap event.

In yet another aspect, the disclosure provides an agricultural harvesting machine. The agricultural harvesting machine includes a module-forming arrangement disposed in a module-forming chamber having an inlet as well as a wrapping material supply roll, a wrap feeding arrangement for delivering wrapping material from the wrapping material supply roll to the module-forming arrangement; at least one wrap feed roll positioned intermediate the wrapping material supply roll and the wrap feeding arrangement for guiding the wrapping material from the wrapping material supply roll to the wrap feeding arrangement, and a sensor arrangement. The sensor arrangement includes a first sensor having a first detection field and a second sensor having a second detection field. The first detection field is directed toward at least one of the wrapping material supply, the wrap feeding arrangement and the at least one wrap feed roll to detect the wrapping material. The second detection field is directed across the module-forming chamber inlet to detect at least a portion of the module extending into the module-forming chamber inlet.

These and other aspects and advantages of the module wrap feed system disclosed herein will become better understood upon consideration of the detailed description of the drawings.

### BRIEF DESCRIPTION OF THE DRAWINGS

FIG. 1 is a schematic side view of an example crop harvesting machine in the form of a cotton harvester, which has a round module-forming and wrapping system;

FIG. 2 is an enlarged view of the round module-forming and wrapping system of the cotton harvester of FIG. 1;

FIG. 3 is an enlarged view of wrap feed components of the wrapping system, including an example sensor arrangement according to the present disclosure;

FIG. 4 is a partial perspective view thereof with parts removed for clarity;

FIG. 5 is an enlarged partial perspective view showing an inlet to a module-forming chamber;

FIG. 6 is a partial side view thereof showing a stream of crop material entering the module-forming chamber to form a module;

FIG. 7 is a partial side view thereof showing a bulging portion of a module in the module-forming chamber at least partially obstructing the inlet;

FIG. 8 is a view similar to FIG. 7 showing a properly wrapped module in the module-forming chamber; and

FIG. 9 is a partial perspective view showing a close-up of a sensor unit at the inlet of the module-forming chamber.

Like reference numerals will be used to refer to like parts from figure to figure in the following detailed description.

### DETAILED DESCRIPTION

The following describes one or more example embodiments of the disclosed module-forming and wrapping system, as illustrated in the accompanying figures of the drawings described briefly above. Various modifications to the example embodiments may be contemplated by one of skill in the art, and it should be understood that the disclosed system may be used with a variety of vehicles in a variety of settings.

As discussed above, in various situations it may be useful to provide a module-forming arrangement for bundling crop material during harvesting. For example, it may be useful to form a chamber defining an interior space with an inlet for receiving crop material therein. The module-forming arrangement and chamber may be configured to form modules having circular (i.e., round bales) or rectangular sections (i.e., square bales). For example, a round module-forming arrangement may be positioned about a circumference of the chamber for forming a round bale. Further, it may be useful to provide a wrap delivery arrangement for guiding a wrapping material about the module to bind the module together for later transport as well as to protect the crop material from debris, moisture or other elements during or after the harvesting process.

In certain situations, it is possible for the wrapping material to be improperly guided into the module-forming chamber or around the module during a wrapping operation. A mis-wrap event may include any occurrence in which a wrapping material deviates from a predetermined path between a supply roll and the module-forming arrangement, including the processes of feeding wrapping material to the module as well as wrapping the module. A mis-wrap event may further include any occurrence in which a module of crop material is improperly wrapped (e.g., incompletely wrapped or unwrapped). For example, a mis-wrap event may result in the accumulation of wrapping material in or around one or more components of the module-forming arrangement or wrap delivery system. One possible outcome of a mis-wrap event is that the wrapping material may become caught on or wound around a wrap roll of the wrap delivery system instead of being properly fed into the module-forming chamber. As a result, a module may be only partially wrapped or completely unwrapped, and the wrapping material may be damaged or wasted, as well as various other problems that may also arise during or after a wrapping operation.

The disclosed system may be used to detect a wrapping material mis-wrap event so that corrective action can be taken to ensure that the module is adequate wrapped and to otherwise minimize the impact of mis-wraps on the machine and harvesting operation. Among other things, a sensor unit may be positioned to detect the absence of the wrapping material on at least a portion of the module of crop material by sensing whether a portion of the module is projecting into the inlet of the module-forming chamber. A sensor unit may additionally or alternatively be positioned to detect the presence or absence of the wrapping material along a path of travel of the wrapping material. One or more additional sensor units may be similarly employed as will be described herein.

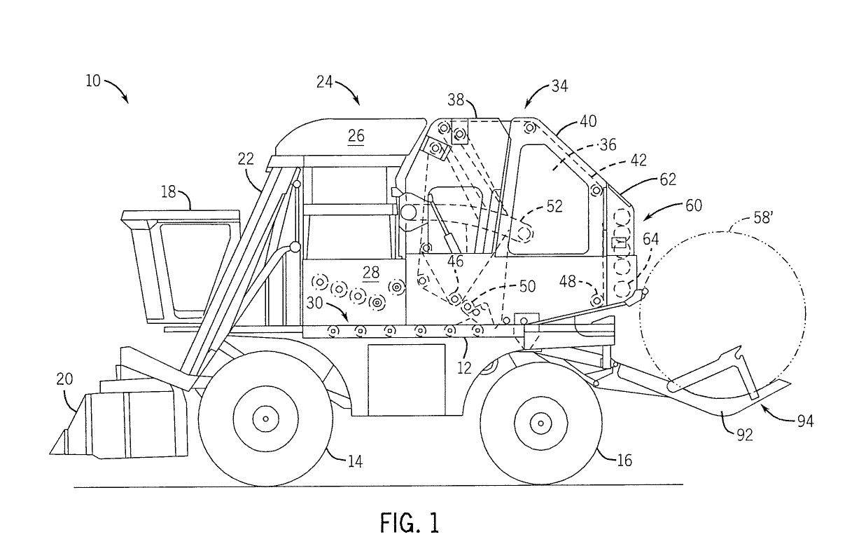

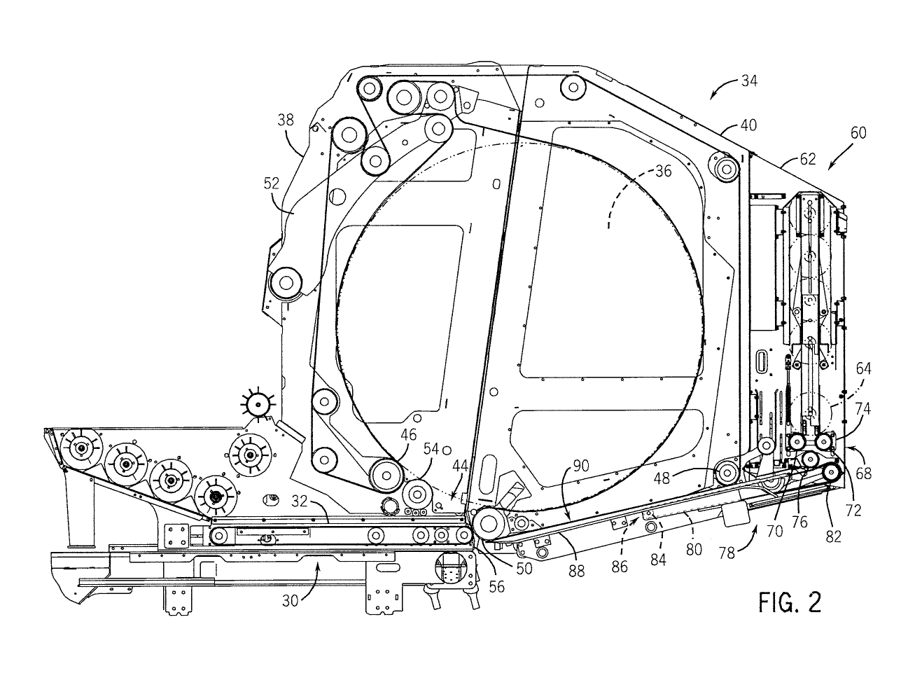

Referring now to FIGS. 1 and 2, there is shown a self-propelled cotton harvester 10 including a chassis frame 12 supported for movement by front drive wheels 14 and rear steerable wheels 16. An operator's station or cab 18 is supported at an elevated forward location of the frame 12 so as to provide an operator a clear view of a harvesting head 20 mounted to a forward end of the frame 12. As is understood, the harvesting head 20 operates to remove cotton bolls from cotton plants, either in a picking or stripping action, and direct the removed cotton bolls into an air conveying system including an air duct arrangement 22 leading to an accumulator 24 with an upper inlet structure 26 and a metering floor 28 supported on the frame 12 behind the cab 18 for receiving the cotton. Beneath the metering floor 28 is a substantially horizontal belt conveyor arrangement 30 including an endless feed belt arrangement 32 (see FIG. 2) that conveys the cotton to an onboard round module-forming (or baler) arrangement 34, which is supported on the frame 12 at a location rearward of the accumulator 24 and is operable for forming large cylindrical modules of harvested cotton.

The module-forming arrangement 34 may include a module-forming chamber 36 of suitable size and shape. Specifically, the module-forming chamber 36 may include a fixed front section 38 mounted to the main frame 12, and a rear section in the form of a discharge gate 40. The gate 40 may have an upper front location mounted to an upper rear location of the front section 38 so as to establish a pivot assembly defining a generally horizontal transverse pivot axis about which the discharge gate 40 may pivot. Any suitable actuator may actuate the gate 40, for example a hydraulic cylinder assembly (not shown), which can move the gate 40 between a lowered baling position, as shown in FIG. 1, and a raised discharge position (not shown) permitting a completed and wrapped cotton module to be discharged beneath it.

With continued reference to FIGS. 1 and 2, the periphery of the module-forming chamber 36 may be defined by the module-forming arrangement 34. For example, the module-forming arrangement 34 may include a plurality of endless members, such as belts 42, for example, formed of one or more sections having ends spliced or pinned together to form a loop, supported in side-by-side relationship across a support roll arrangement of fixed and movable support rolls. Specifically, proceeding clockwise from an upper boundary of an inlet 44 near the bottom of the module-forming chamber 36, the support roll arrangement includes a stationary lower forward roll 46, a stationary bottom rear gate roll 48 and a stationary bottom front gate roll 50 all extending between and having opposite ends rotatably mounted to the front section 38 or the gate 40 at the sides of the module-forming arrangement 34. The module-forming arrangement 34 also includes a belt tensioning arm 52 mounted within the module-forming chamber 36.

In an initial position corresponding to when the module-forming chamber 36 is in an empty condition, the module-forming belts 42 define the perimeter of the module-forming chamber 36, which may be initially a generally triangular shape, as viewed from the side. The tensioning arm 52 may include tensioning elements (not shown) so as to yieldably resist their upward movement as the module-forming chamber 36 becomes filled with cotton. One or more of the stationary rolls 46, 48, 50 are driven so as to cause the belts 42 to be driven, with the drive direction being such as to cause the incoming cotton to travel counterclockwise as it is added as a spiral layer to the growing module. To aid in this counterclockwise movement of the cotton during initial formation of the module, a driven starter roll 54 extends between a front section of the module-forming chamber 36. As viewed in FIG. 2, the starter roll 54 is driven clockwise so as to strip the cotton conveyed by the downwardly traveling run of the belts 42 forming the front of the triangular shaped space, with the result being that the cotton is spiral-wound into a cylinder, which grows and expands against the tensioned belts until a module of a desired diameter is formed.

As can be seen in FIG. 2, the conveyor arrangement 30 has a rear terminal end 56 located adjacent a front periphery of the lower front gate roll 50 so that cotton is conveyed directly against the belts 42 engaged with the lower front gate roll 50. When the discharge gate 40 is in its lowered, baling position the forward roll 46 and the starter roll 54 at the front section 38 of the module-forming chamber 36 are each located at a height above the height of the lower front gate roll 50, with the rolls 46, 50 and 54 being located so that their peripheries are positioned to engage the circumference of a completed cotton module 58 located in the module-forming chamber 36.

A module (or bale) wrapping system 60 may be mounted at the rear of the discharge gate 40 for the purpose of wrapping the completed module of cotton 58 so as to hold it together, and possibly protect it from the elements, after it is discharged from the cotton harvester 10. The wrapping system 60 may include a cover 62 covering an active wrapping material supply roll 64 on which wrapping material 66 is wound. The wrapping material 66 may be any suitable wrapping material, such as including netting or sheet wrap. It should be noted that the principles of this disclosure may be employed for use with twine or other line type wrapping material and a knotter or like assembly, which may be provided in addition to, or instead of, the module-forming arrangement 34 described herein.

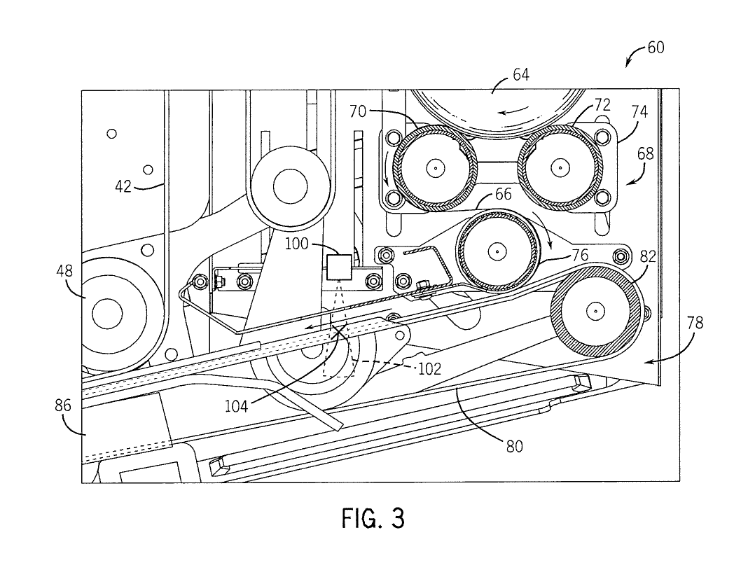

With reference to FIGS. 1-3, the supply roll 64 may be mounted on an upper wrap roller assembly 68 that includes a front upper wrap roll 70 and a rear upper wrap roll 72 mounted for rotation on a moveable carriage 74. The supply roll 64 can be rotated in a clockwise direction as viewed in FIG. 3, such that an end section of wrapping material 66 may extend around a forward side of the front upper wrap roll 70 and be fed between the front upper wrap roll 70 and a lower wrap roll 76. The carriage 74 may be transitioned from a raised position (as shown in FIG. 3) to a lowered position (not shown) such that the front upper wrap roll 70 and the rear upper wrap roll 72 are in contact with the lower wrap roll 76.

The lower wrap roll 76 may be positioned above a wrap conveyor arrangement 78, including a plurality of endless wrap feed belts 80, that conveys the wrapping material 66 toward the module-forming chamber 36. The wrap feed belts 80 may be supported on rear wrap conveyor roll 82 and a front wrap conveyor roll 84. A forward section 86 of the wrap conveyor arrangement 78 may be positioned beneath a section of the module-forming belts 42 that extends between the bottom rear gate roll 48 and the bottom front gate roll 50.

Continuing toward the module-forming chamber 36, a wrap floor 88 may be positioned forward of the wrap conveyor arrangement 78 and beneath the section of module-forming belts 42 that extends between the bottom rear gate roll 48 and the bottom front gate roll 50. An upper face 90 of the wrap floor 88 may be generally aligned with the wrap feed belts 80. Accordingly, at the beginning of a wrapping cycle, the front upper wrap roll 70, rear upper wrap roll 72, and lower wrap roll 76 are actuated to deliver a length of wrapping material 66 against the wrap feed belts 80. The wrap material 66 may then be carried toward the forward section 86 of the wrap conveyor arrangement 78 where the wrapping material 66 is drawn between the module-forming belts 42 and the wrap feed belts 80. The module-forming belts 42 guide the wrapping material 66 along the belts of the wrap floor 88, and then around the lower front gate roll 50 proximate the terminal end 56 of the conveyor arrangement 30 and into the module-forming chamber 36, by way of the chamber inlet 44.

Upon entering the module-forming chamber 36, the length of wrapping material 66 is trapped between the module-forming belts 42 and the completed cotton module 58. The speed at which the wrapping material 66 is moved by the belts 42 and the rotating module 58 may be greater than the speed at which it is delivered by the wrap feed rolls 70, 72 and 76, causing the wrapping material 66 to be tensioned and stretched as it is wrapped about the module 58. Once a desired length of the wrapping material 66 (three wraps or revolutions, for example) is wrapped about the module 58, the wrap feed rolls 70, 72 and 76 are paused and the wrapping material 66 associated with the module 58 is separated from the remaining wrapping material 66 associated with the supply roll 64. In some embodiments, the wrapping material 66 may be cut, for example, with a knife, laser or other cutting implement. In other embodiments, a supply roll 64 may include pre-partitioned lengths of wrapping material 66.

In the case of pre-partitioned lengths of wrapping material 66, it is possible that adjacent segments of the wrapping material 66 may be interleaved together at a lapped joint, which may be connected together by an adhesive permitting separation of the joint upon the application of a predetermined tensile force without requiring a cutting mechanism. Rather, all that is required is to apply a braking force to the supply roll 64, with the wrapping action of the module 58 and module-forming belts 42 creating the tensile force necessary for separating the joint. Separation of the joint then exposes adhesive which serves to adhere the outer end section to the underlying layer of wrapping material 66. Further, each segment or pre-partitioned length of wrapping material 66 may be a predetermined length sufficient for providing a desired number of wraps about the circumference of a module 58 having a predetermined diameter. Thus, each of the wrapping material supply rolls 64 may be manufactured to wrap a given number of modules 58 having a predetermined diameter.

Upon completion of a wrapping cycle, a signal may be provided to a controller (not shown) located in the cab 18 of the harvester 10 for initiating transfer of the wrapped module 58′ from the module-forming chamber 36. For example, the operator may cause a pair of hydraulic gate cylinders (not shown) to actuate and pivot the discharge gate 40 to its raised discharge position so that the wrapped module 58′ may roll onto a cradle-shaped framework 92 of a module discharge arrangement 94. The module 58′ may then be ejected from the cotton harvester 10 at a desired time and location.

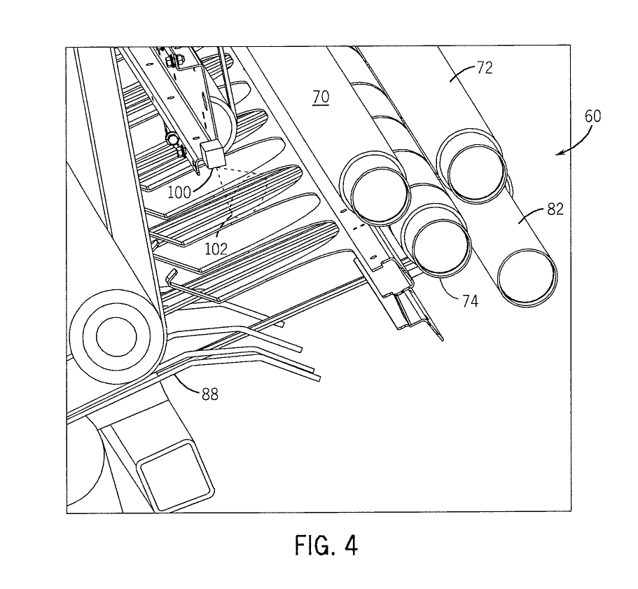

Turning now to FIGS. 3 and 4, a first sensor unit 100 may be positioned forward of the wrap feed rolls 70, 72 and 76 proximate the conveyor arrangement 78 for sensing the absence, presence or another characteristic of the wrapping material 66. The sensor unit 10 can be any suitable sensor operatively coupled (e.g., via bus or other electrical connection) to a computer or control device (not shown) capable of receiving the input signals from the sensor unit 100, processing the signals and providing an output to the operator (e.g., an alert or other feedback signal) or to control one or more components of the wrapping system, the module-forming system or other systems of the cotton harvester 10 based on the input signals from the sensor unit 100.

In some embodiments, the sensor unit 100 may be an ultrasonic sensor. In general, an ultrasonic sensor may be configured to evaluate a characteristic of a target by generating high frequency sound waves and analyzing the echo of those sound waves that are reflected back off the target toward the ultrasonic sensor. An active ultrasonic sensor may measure the time interval between an ultrasonic output signal and a (reflected) input signal to determine the distance to (or the presence of) an object. By comparison, a passive ultrasonic sensor may be configured to detect an input signal without generating an output signal. In other embodiments, the sensor unit 100 may be another type of passive or active sensor or detector. Examples of suitable sensors/detectors include various pressure, motion, optical (e.g., ultraviolet, infrared, visible light), acoustic (e.g., ultrasonic), and other like proximity sensors or detectors. Suitable sensors and detectors may also include various imaging devices. Depending on the sensor unit the scanning field may be any suitable wide or narrow configuration, including conical and cylindrical beams.

In some embodiments, the sensor unit 100 may be oriented or otherwise configured to detect a characteristic of the wrap material 66 upstream of the module-forming chamber 36 (i.e., along the path traveled by the wrapping material 66 from the supply roll 64 to the inlet 44 of the module-forming chamber 36). For example, the sensor unit 100 may be oriented to detect the presence or absence of the wrapping material 66 on the front upper feed roll 70, the rear upper feed roll 72, the lower wrap feed roll 76, the wrap feed belts 80, or the wrap floor 88. Further, the sensor unit 100 may be oriented to detect a direction of travel of the wrapping material 66, bunching or folding of the wrapping material 66, the presence of a marker (e.g., printing, embossing, cut-outs, RFID tags, or the like) on the wrapping material 66, or another characteristic of the wrapping material 66.

In the example shown in FIGS. 3 and 4, the sensor unit 100 is oriented toward the wrap feed belts 80 to detect the presence or absence of wrapping material 66 present thereon. As discussed above, a wrapping material 66 mis-wrap event may result from an obstruction that hinders the leading edge of the wrapping material 66 from feeding into the module-forming chamber 36. The mis-wrap event may result in the bunching or accumulation of wrapping material 66 proximate the wrap floor 88 that may become caught on the lower wrap feed roll 76. As a consequence, the lower wrap feed roll 76 may wind up the wrapping material 66 pulling from the wrapping material 66 that has accumulated on the wrap floor 88, the wrapping material 66 feeding off the supply roll 64, or a combination thereof, which may result in winding a significant lengths of wrapping material 66 around the lower wrap feed roll 76. Accordingly, it may be useful to position the sensor unit 100 as shown in FIGS. 3 and 4 to detect such an occurrence.

With continued reference to FIGS. 3 and 4, the sensor unit 100 may provide a conical scanning range or field 102, as indicated by the dashed lines. The field 102 may be adjusted to encompass a target 104, indicated in the figures by the region of interest “X”. The target 104 may correspond with a possible location of the wrapping material 66 during normal (i.e., unperturbed) feeding of the wrapping material 66 to the module-forming chamber 36. For example, it may be useful to detect a leading edge of the wrapping material 66 as it passed through the field 102 of the sensor. Alternatively, the target 104 may correspond with a position occupied by the wrapping material 66 when bunched up due to accumulation of the wrapping material 66 on the wrap floor 88, or when otherwise perturbed from a normal path of travel.

In another embodiment, the sensor unit 100 may be oriented towards the lower wrap feed roll 76 such that the field 102 overlaps with a portion of the lower wrap feed roll 76. For example, the sensor unit 100 may be positioned such that the target 104 corresponds with a surface of the lower wrap feed roll 76. As the wrapping material 66 is fed about the lower wrap feed roll 76, the target 104 may be positioned for the sensor unit 100 to detect whether more than a single layer of wrapping material 66 is detected by the sensor unit 100. In one aspect, the presence of two or more layers of wrapping material 66 may result in a decreased relative distance between the sensor unit and a surface of the wrapping material 66 on the lower wrap feed roll 76 as compared with the presence of a single layer of wrapping material 66 on the lower wrap feed roll 76. This distance may be detectable using an ultrasonic or another type of sensor unit 100.

In another aspect, the number of layers of the wrapping material 66 may correspond with a detectable change in the opacity or transparency of the wrapping material 66 on the surface of the lower wrap feed roll 76. For example, a single layer of wrapping material 66 may have a given absorbance, reflectance, transmittance or other like property, whereas two or more layers of the wrapping material 66 may have an increased absorbance or reflectance, or a decreased transmittance. Properties such as the absorbance, reflectance or transmittance may be measured with a natural (e.g., sunlight) or artificial (e.g., a fluorescent or halogen lamp, an LED, or the like) source or light. In one aspect, the sensor unit 100 may include a light source. In another aspect, the light source may be positioned on or in one or more of the components of the cotton harvester 10. In one example, a light source may be positioned within the lower wrap feed roll 76 such that light is transmitted through the lower wrap feed roll 76. In another example, a light source may be positioned to reflect off of a surface of the lower wrap feed roll 76, such that the reflected light is detectable with the sensor unit 100. In a further example, light may be transmitted through the lower feed roll for detection by a sensor unit 100 positioned within the lower wrap feed roll 76.

It will be appreciated that while the particular example of a light source has been described for the detection of a characteristic of the wrapping material 66, an alternative or additional source of electromagnetic or mechanical energy may be relied upon. For example, it may be useful to provide a sensor unit 100 configured to detect the transmission of a sound wave through, or the reflectance of a sound wave off of, the wrapping material 66. Other types of sensor unit and detection methods will similarly fall within the scope of the present disclosure. Further, while characteristics of the wrapping material 66 have been described including the reflectance, transmittance, absorbance, opacity, speed, direction of travel, markings, and physical conformation, other characteristics may similarly be detected or measured. For example, it may be useful to detect position of a leading edge of the wrapping material 66 in a direction transverse to the cotton harvester 10. Moreover, it may be useful to measure a characteristic of the wrapping material 66 with a single sensor unit 100, or two or more similar or dissimilar sensor units 100.

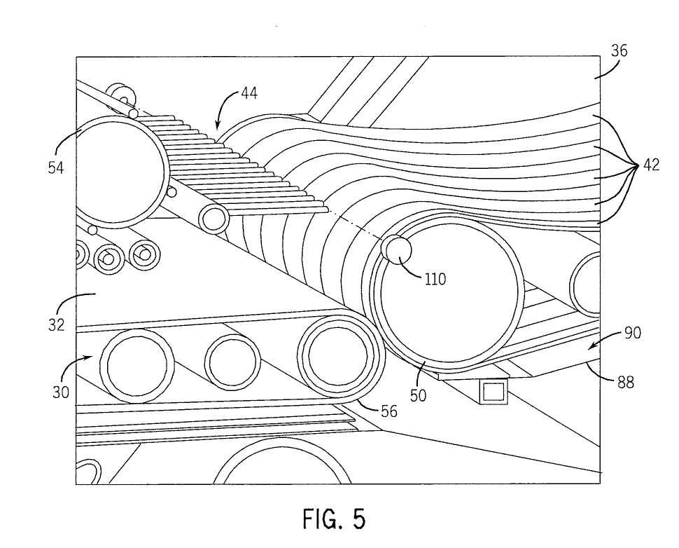

While various techniques have been described for the detection of a characteristic of the wrapping material 66 upstream of the module-forming chamber 36, further embodiments of the present disclosure relate to the detection of a characteristic of the wrapping material 66 within, or in the vicinity of, the module-forming chamber 36. Turning to FIGS. 5-8, a sensor unit 110 may be positioned proximate the lower front gate roll 50. The sensor unit 110 may be configured for the detection of the presence or a characteristic of the wrapping material 66 proximate the wrap floor 88, the lower front gate roll 50, the conveyor arrangement 30 including the rear terminal end 56, the forward roll 46, the starter roll 54, or other components of the cotton harvester 10 near of the inlet 44. Like the sensor unit 100, the sensor unit 110 can be any suitable sensor operatively coupled (e.g., via bus or other electrical connection) to a computer or control device (not shown) capable of receiving the input signals from the sensor unit 110, processing the signals and providing an output to the operator (e.g., an alert or other feedback signal) or to control one or more components of the wrapping system, the module-forming system or other systems of the cotton harvester 10 based on the input signals from the sensor unit 110.

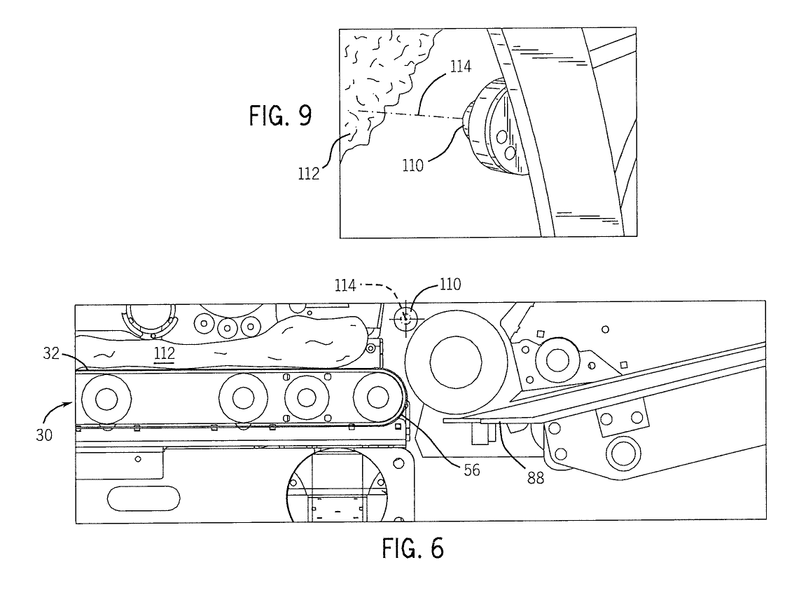

Alternatively, or in addition, the sensor unit 110 may be configured for the detection of the presence or a characteristic of the module 58. For example, the sensor unit 110 may be positioned for the detection of the presence or absence of a portion of the cotton module 58 proximate the inlet 44. With reference to FIG. 6, it may be seen that a stream of material 112 may pass along the conveyor arrangement 30 toward the rear terminal end 56. The material 112 may pass through the inlet 44 into the module-forming chamber 36, wherein the material 112 may be incorporated into the (growing) module 58. As shown in FIG. 9, the sensor 110 may be positioned proximate the lower front gate roll 50 (e.g., mounted on a sidewall of the cotton harvester 10) with a scanning range or field 114 of the sensor unit 110 oriented across the inlet 44. In one aspect, the sensor unit 110 may be an optical sensor with a transmitter and receiver on opposite sidewalls of the harvester for the detection of the presence or absence of an object positioned across the module-forming chamber 36.

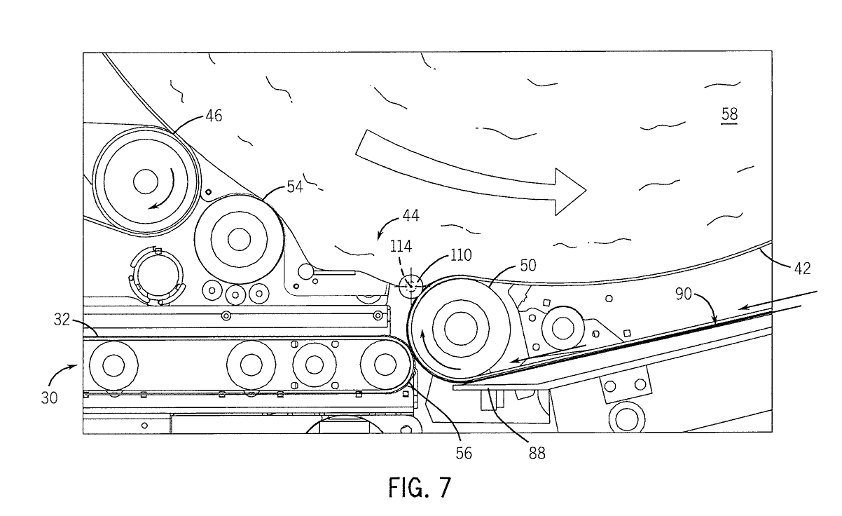

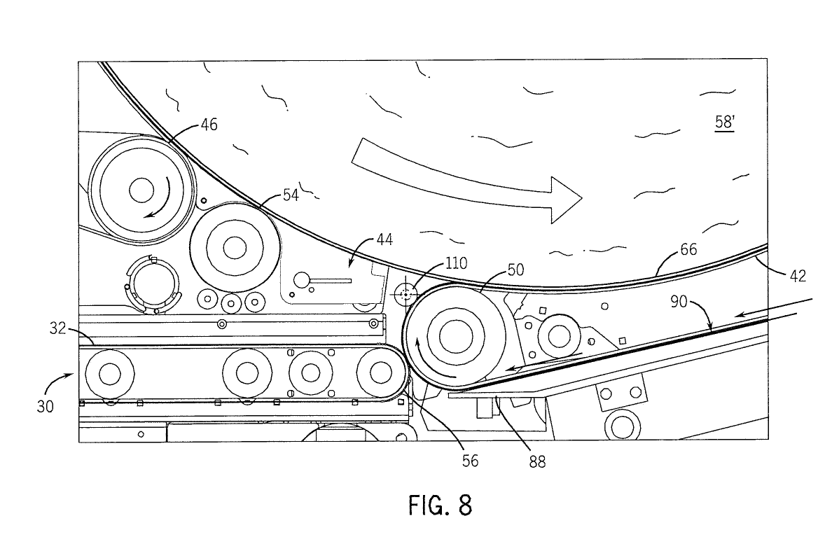

Turning to FIGS. 7 and 8, during a module-forming operation, the flow of crop material 112 into the module-forming chamber 36 through the inlet 44 may cease for various reasons. For example, an operator may select a setting on the cotton harvester 10 to prevent the intake of further crop material 112, or their may be no additional crop material 112 to harvest. There may be a tendency for the crop material 112 at the surface of the module 58 to expand into the inlet 44 in the space ahead of the lower front gate roll 50, as shown in FIG. 7. In the case that a bulging portion of the module 58 is within the field 114, the sensor unit 110 may detect that there is an object obstructing the inlet 44, which may be indicative that the module 58 is unwrapped or improperly wrapped. By comparison, if the module 58 is properly wrapped with wrapping material 66, then the field 114 of the sensor unit 110 may be unobstructed. For example, in the case of a properly wrapped module 58, no material 112 or portion of the module 58 may expand into the inlet 44, as shown in FIG. 8.

In some embodiments, detection of the presence or a particular characteristic of the wrapping material 66 or the module 58 may actuate one or more components of the cotton harvester 10. For example, a detection event may actuate a visual, audible, or tactile (e.g., haptic) alert to an operator of the cotton harvester 10. The alert may indicate a mis-wrap event, such as mis-feeding of the wrapping material 66, an unwrapped or partially wrapped state of the module 58 or another state of the wrapping material 66 or the module 58. Further, the alert may include an indication as to the nature, location, severity or other aspect based on the particular characteristic detected by the sensor units 100, 110. In one example, the sensor unit 100 may detect a mis-wrap event, such as the accumulation of wrapping material 66 on the lower wrap feed roll 76 or on the wrap floor 88. Thereafter, the sensor unit 100 may provide an alert to an operator of the cotton harvester 10. In another example, the sensor unit 110 may detect that at least a portion of the module 58 is extending into the inlet 44 from the module-forming chamber 36. Thereafter, the sensor unit 110 may provide an alert to an operator of the cotton harvester 10. The two alerts may be the same, or they may be different so as to differentiate and help pin-point the type or area of the mis-wrap event.

In some embodiments, an operator may be able to respond to the alert. For example, the operator may be able to control the cotton harvester 10 to enter a wrapping material loading mode in order to rewind at least a portion of the wrapping material 66 back onto the supply roll 64. The rewinding operation may resolve the mis-wrap event or enable the operator to re-feed the wrapping material 66 into the wrap floor. In one aspect, providing an operator with the ability to resolve a mis-wrap event may reduce the potential for wasted wrapping material 66. Further, the amount of time required for an operator to mitigate a mis-wrap event from the cab 18 of the cotton harvester 10 may be less than the time required to pause a harvesting operation to manually remove one or more portions of mis-fed wrapping material from a feed roll or another location within the cotton harvester 10.

In some embodiments, detection of the presence or a particular characteristic of the wrapping material 66 or the module 58 may trigger an automated response from one or more components of the cotton harvester 10. For example, if the wrapping material 66 becomes wound around the lower wrap feed roll 76, the sensor unit 100 may communicate with one or more components of the cotton harvester 10 (e.g., a drive system for the supply roll 64 or a wrap feed roll 70, 72 or 74) to cease any further delivery of the wrapping material 66 to the module-forming chamber 36, possibly by the sensor unit 100 communicating with a relay that cuts power to a clutch for the lower wrap feed roll 76.

As will be appreciated by one skilled in the art, various aspects of the disclosed subject matter may be embodied as a computer-implemented method, a system, or a computer program product. Accordingly, certain implementations may be implemented entirely as hardware, entirely as software (including firmware, resident software, micro-code, etc.) or as a combination of software and hardware aspects. Furthermore, certain implementations may take the form of a computer program product on a computer-usable storage medium having computer-usable program code embodied in the medium.

Any suitable computer usable or computer readable medium may be utilized. The computer usable medium may be a computer readable signal medium or a computer readable storage medium. A computer-usable, or computer-readable, storage medium (including a storage device associated with a computing device or client electronic device) may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium may be any tangible medium that can contain, or store a program for use by or in connection with the instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be non-transitory and may be any computer readable medium that is not a computer readable storage medium and that can communicate, propagate, or transport a program for use by or in connection with an instruction execution system, apparatus, or device.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the any use of terms “comprises” and/or “comprising” in this specification specifies the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

Each reference identified above is incorporated by reference in its entirety.

1. A wrap feed system for a module-forming arrangement in an agricultural harvesting machine, the system comprising:
a wrap feeding arrangement for delivering wrapping material from a wrapping material supply to the module-forming arrangement disposed in a module-forming chamber having an inlet;
a guide arrangement guiding the wrapping material from the wrapping material supply to the wrap feeding arrangement; and
a sensor arrangement having at least one detection field directed toward at least one of the wrapping material supply, the wrap feeding arrangement, the guide arrangement and the module-forming chamber inlet to detect at least one of a module and the wrapping material.

2. The system of claim 1, wherein the module-forming arrangement includes at least one endless member disposed about a plurality of support rolls and defining a periphery of the module as it is formed in the module-forming arrangement.

3. The system of claim 2, wherein the module-forming arrangement includes a tensioning arm biasing the at least one endless member in tension.

4. The system of claim 1, wherein the sensor arrangement includes a first sensor having a first detection field and a second sensor having a second detection field, wherein the first and second detection fields are directed toward different one of the wrapping material supply, the wrap feeding arrangement, the guide arrangement and the module-forming chamber inlet.

5. The system of claim 4, wherein the first detection field is directed toward at least one of the wrapping material supply, the wrap feeding arrangement and the guide arrangement to detect the wrapping material, and wherein the second detection field is directed across the module-forming chamber inlet to detect at least a portion of the module extending into the module-forming chamber inlet.

6. The system of claim 5, wherein the first sensor detects an absence of the wrapping material in the first detection field.

7. The system of claim 5, wherein the first sensor is an acoustic sensor and the second sensor is an optical sensor.

8. The system of claim 1, further including a controller operatively coupled to the sensor arrangement and configured to receive sensor input and output a feedback signal indicative of a mis-wrap event.

9. The system of claim 8, wherein the feedback signal is at least one of an operator alert or a control signal for controlling a component of the wrapping system or the module-forming arrangement.

10. The system of claim 8, wherein the mis-wrap event corresponds to the module being at least partially unwrapped at the end of a wrap cycle.

11. A wrap feed system for a module-forming arrangement in an agricultural harvesting machine, the system comprising:
a wrap feeding arrangement for delivering wrapping material from a wrapping material supply to the module-forming arrangement disposed in a module-forming chamber having an inlet;
at least one wrap feed roll positioned intermediate the wrapping material supply and the wrap feeding arrangement for guiding the wrapping material from the wrapping material supply to the wrap feeding arrangement;
a sensor arrangement including:
a first sensor having a first detection field; and
a second sensor having a second detection field;
wherein the first detection field is directed toward at least one of the wrapping material supply, the wrap feeding arrangement and the at least one wrap feed roll to detect the wrapping material, and wherein the second detection field is directed across the module-forming chamber inlet to detect at least a portion of the module extending into the module-forming chamber inlet; and
a control system including at least one controller operatively coupled to the first and second sensors and configured to receive sensor input and output a feedback signal indicative of a mis-wrap event.

12. The system of claim 11, wherein at least one of the first and second sensors detects an absence of the wrapping material in at least one of the first and second detection fields.

13. The system of claim 11, wherein the first sensor is an acoustic sensor and the second sensor is an optical sensor.

14. The system of claim 11, wherein the mis-wrap event corresponds to the module being at least partially unwrapped at the end of a wrap cycle.

15. An agricultural harvesting machine, comprising:
a module-forming arrangement disposed in a module-forming chamber having an inlet;
a wrapping material supply roll;
a wrap feeding arrangement for delivering wrapping material from the wrapping material supply roll to the module-forming arrangement;
at least one wrap feed roll positioned intermediate the wrapping material supply roll and the wrap feeding arrangement for guiding the wrapping material from the wrapping material supply roll to the wrap feeding arrangement; and
a sensor arrangement including:
a first sensor having a first detection field; and
a second sensor having a second detection field;
wherein the first detection field is directed toward at least one of the wrapping material supply, the wrap feeding arrangement and the at least one wrap feed roll to detect the wrapping material, and wherein the second detection field is directed across the module-forming chamber inlet to detect at least a portion of the module extending into the module-forming chamber inlet.

16. The agricultural harvesting machine of claim 15, further including a control system including at least one controller operatively coupled to the first and second sensors and configured to receive sensor input and output a feedback signal indicative of a mis-wrap event.

17. The agricultural harvesting machine of claim 16, wherein the mis-wrap event corresponds to the module being at least partially unwrapped at the end of a wrap cycle.

18. The agricultural harvesting machine of claim 16, wherein the feedback signal is at least one of an operator alert or a control signal for controlling the at least one wrap feed roll and the module-forming arrangement.

19. The agricultural harvesting machine of claim 15, wherein the first sensor is an acoustic sensor and the second sensor is an optical sensor.

20. The agricultural harvesting machine of claim 15, wherein the module-forming arrangement includes at least one endless member disposed about a plurality of support rolls and defining a periphery of the module as it is formed in the module-forming arrangement, and includes a tensioning arm biasing the at least one endless member in tension.
